(19) United States
(12) Patent Application Publication
(10) Pub. No.: US 2026/0125494 A1
(43) Pub. Date: May 7, 2026

(54) METHOD FOR IMPROVING THE DEGRADATION STABILITY OF POLYSTYRENE COMPOSITIONS IN RECYCLING PROCESSES

(71) Applicant: INEOS STYROLUTION GROUP GMBH, Frankfurt am Main (DE)

(72) Inventors: Norbert NIESSNER, Friedelsheim (DE); Frank EISENTRAEGER, Vufflens-le-Chateau (CH)

(21) Appl. No.: 18/994,911

(22) PCT Filed: Jul. 17, 2023
(86) PCT No.: PCT/EP2023/069760

§ 371 Date: Jan. 15, 2025

(30) Foreign Application Priority Data
Jul. 18, 2022 (EP) 22185385.6

(51) Int. Cl. C08F 12/08; C08J 3/20; C08K 5/06; C08K 5/372; C08K 5/524

(52) U.S. Cl. CPC C08F 12/08; C08J 3/203; C08K 5/06; C08K 5/372; C08K 5/524

(57) ABSTRACT

The invention relates to a method for improving the degradation stability of a polystyrene composition in recycling processes. The invention also relates to the use of less than 0.4 wt.-% of stabilizer components for improving the degradation stability of polystyrene compositions in recycling processes and to polystyrene compositions with improved degradation stability.

The present invention relates to a method for improving the degradation stability of a polystyrene (PS) composition in a recycling process. The invention describes the use of stabilizer components for improving the degradation stability of polystyrene compositions in recycling processes and to polystyrene compositions with improved degradation stability.

Products made from or incorporating plastic components are part of many work places or home environment. Most of these plastics are virgin polymers that are produced from petroleum. In recent years, there has been a strong movement towards recycling and reuse of petrochemical products, such as plastics, in addition to metallic material. Recycling plastic from waste plastic materials has a variety of benefits compared to producing virgin plastic from petroleum, e.g. less energy is required, the need for disposing waste material is reduced, and the use of limited geological resources, such as petroleum, is reduced. Often, waste plastic materials include post-consumer and post-industrial waste materials and plastic scrap, including polymer types such as general purpose polystyrene (GPPS) and high impact polystyrene (HIPS).

Processing of polystyrene compositions, e.g. during recycling processes, often leads to polystyrene degradation due to a combination of mechanical stress, thermolysis and oxidation. Elevated temperatures promote the generation of monomers, e.g. styrene monomers, due to degradation of the polystyrene during processing considerably. The ceiling behavior of commercial polystyrene materials typically leads to residual monomer contents of 400 ppm styrene monomer at 220° C. and 1500 ppm styrene monomer at 260° C.

In order to use recycled polystyrene compositions in particular in food packaging, it is inevitable to minimize the residual styrene content in the recycled styrene composition since styrenic monomers can migrate from the packaging material into food. Recycled polystyrene compositions are prone to comprise and/or emit increased amounts of residual styrenic monomers due to the repeated thermal and/or mechanical processing they undergo during the recycling process.

The quest for polystyrenes with low residual monomer content, especially after post-consumer recycling, requires grades that do not build up styrene monomers during processing. Processing leads to polystyrene degradation due to a combination of mechanical stress, thermolysis and oxidation (W. Loth “Kinetik und Mechanismus des Abbaus”, H. Gausepohl und R. Gellert Eds. “Polystyrol”, Kunsttoff-Handbuch 4, Hanser Verlag, München 1996).

In day-to-day applications, low residual levels are especially important in the food packaging sector. Here, semi-impact HIPS or GPPS/HIPS blends are used. Literature results indicate that a stabilization of HIPS can help reducing residual content as well.

Thus, there is a high demand of polystyrene compositions with low residual monomer content and reduced emission of monomers, e.g. styrene, due to degradation of the polystyrene during processing.

It was surprisingly found that increased amounts of stabilizer components can lead to an increase in styrene monomer formation during processing of high impact polystyrene. This result was confirmed with a multitude of different stabilizers components. After extensive studies, the inventors of the present invention found a method for improving the degradation stability of polystyrene compositions as described herein.

### DETAILED DESCRIPTION OF THE INVENTION

The invention relates to a method for improving the degradation stability of a polystyrene composition P in recycling processes, wherein the method comprises admixing at least one polystyrene component as component A with 0.01 to less than 0.4 wt.-%, preferably 0.02 to 0.3 wt.-%, often 0.03 to 0.2 wt.-%, for example 0.04 to 0.15 wt.-%, based on the total weight of the polystyrene composition P, of at least one stabilizer component as component B and optionally at least one additive as component C,
wherein the at least one polystyrene component A comprises:
A-1: at least one impact-modified polystyrene as component A-1; and/or
A-2: at least one non-impact modified polystyrene as component A-2;
and wherein the at least one stabilizer component B comprises at least one component selected from:
B-1: at least one sterically hindered phenolic antioxidant as component B-1;
B-2: optionally at least one phosphor-containing co-stabilizer as component B-2; and
B-3: optionally at least one sulfur-containing co-stabilizer as component B-3.

Preferably, the polystyrene composition P comprises (or consists of):
(i) at least one impact-modified polystyrene A-1, and at least one sterically hindered phenolic antioxidants B-1; or
(ii) at least one impact-modified polystyrene A-1, and at least two sterically hindered phenolic antioxidants B-1; or
(iii) at least one impact-modified polystyrene A-1, at least one sterically hindered phenolic antioxidant B-1 and at least one phosphorous-containing co-stabilizer B-2; or
(iv) at least one impact-modified polystyrene A-1, at least one sterically hindered phenolic antioxidant B-1 and at least one sulfur-containing co-stabilizer B-3; or
(v) at least one non-impact-modified polystyrene A-2, and at least one sterically hindered phenolic antioxidant B-1.

It was found that polystyrene compositions P comprising impact-modified polystyrene components A-1, such as high-impact polystyrene (HIPS), perform worse during thermal treatment when typical thermal stabilizers including stabilizer components B are used in amounts of 0.4 wt.-% and more. A good stabilization can be found even when low amounts of thermal stabilizer is used. For example, thermal stabilizers B in amounts as low as 0.04 to 0.15 wt.-% are often sufficient to achieve good degradation stability during thermal treatment.

In case only non-impact-modified polystyrene components A-2 such as general purpose polystyrene (GPPS) are present, at least one sterically hindered phenolic antioxidant B-1 is typically sufficient in order to improve its degradation stability during recycling processes. However, also for non-impact-modified polystyrene components A-2, the presence of more than one sterically hindered phenolic antioxidant B-1 or combinations of at least one phosphorous-containing co-stabilizer B-2 and/or at least one sulfur-containing co-stabilizer B-3 with at least one sterically hindered phenolic antioxidant B-1 are suitable and are an embodiment of the invention.

The invention also includes polymer blends of impact-modified polystyrene components A-1 and non-impact-modified polystyrene components A-2. According to the invention, these blends require the presence of at least one sterically hindered phenolic antioxidant B-1. The at least one sterically hindered phenolic antioxidant B-1 is preferably combined with at least one further sterically hindered phenolic antioxidant B-1, at least one phosphorous-containing co-stabilizer B-2 and/or at least one sulfur-containing co-stabilizer B-3.

If a polymer blend of impact-modified polystyrene components A-1 and non-impact-modified polystyrene components A-2 is prepared, it is often sufficient to blend a non-impact-modified polystyrene component A-2 with an impact-modified polystyrene component A-1 which already comprises the sufficient stabilizer component(s) B. Although possible, it is not required to combine the non-impact-modified polystyrene components A-2 with the stabilizer component(s) B before blending with the impact-modified polystyrene components A-1.

Thus, according to one embodiment, the invention relates to a method for improving the degradation stability of a polystyrene composition P in recycling processes, wherein the at least one polystyrene component A is selected from:
A-1: at least one impact-modified polystyrene as component A-1;
provided that the polystyrene composition comprises (or consists of):
(i) at least one impact-modified polystyrene A-1, and at least one sterically hindered phenolic antioxidants B-1; or
(ii) at least one impact-modified polystyrene A-1, and at least two sterically hindered phenolic antioxidants B-1; or
(iii) at least one impact-modified polystyrene A-1, at least one sterically hindered phenolic antioxidant B-1 and at least one phosphorous-containing co-stabilizer B-2; or
(iv) at least one impact-modified polystyrene A-1, at least one sterically hindered phenolic antioxidant B-1 and at least one sulfur-containing co-stabilizer B-3.

According to an alternative embodiment, the invention relates to a method for improving the degradation stability of a polystyrene composition P in recycling processes, wherein the at least one polystyrene component A is selected from:
A-2: at least one non-impact modified polystyrene as component A-2;
provided that the polystyrene composition comprises (or consists of):
(i) at least one non-impact-modified polystyrene A-2, and at least one sterically hindered phenolic antioxidant B-1.

The invention also relates to a method for improving the degradation stability of a polystyrene composition P in recycling processes, wherein the at least one polystyrene component A is selected from:
A-1: at least one impact-modified polystyrene as component A-1; and
A-2: at least one non-impact modified polystyrene as component A-2;
provided that the polystyrene composition comprises:
(i) at least one sterically hindered phenolic antioxidants B-1; or
(ii) at least two sterically hindered phenolic antioxidants B-1; or
(iii) at least one sterically hindered phenolic antioxidant B-1 and at least one phosphorous-containing co-stabilizer B-2; or
(iv) at least one sterically hindered phenolic antioxidant B-1 and at least one sulfur-containing co-stabilizer B-3.

The method for improving the degradation stability of a polystyrene composition P in recycling processes preferably includes the following process steps:
a) providing at least one impact-modified polystyrene A-1 and/or at least one non-impact modified polystyrene A-2 as component A;
b) providing at least one sterically hindered phenolic antioxidant B-1, optionally at least one further sterically hindered phenolic antioxidant B-1, different from the first sterically hindered phenolic antioxidant B-1, optionally at least one phosphor-containing co-stabilizer B-2 and/or optionally at least one sulfur-containing co-stabilizer B-3 as component B;
c) optionally providing at least one additive as component C;
d) admixing the component(s) A with:
   0.01 to less than 0.4 wt.-%, preferably 0.02 to 0.3 wt.-%, often 0.03 to 0.2 wt.-%, for example 0.04 to 0.15 wt.-%, based on the total weight of the polystyrene composition P, of component B, and
   optionally component(s) C to obtain the polystyrene composition P;
e) optionally extruding and cooling the obtained polystyrene composition P.

The admixing step c) may be performed by processes known per se. For example extruders, such as co-rotating or counter rotating single or twin screw extruders, or other conventional kneading apparatuses, such as continuous or batch kneaders, Brabender mixers or Banbury mixers, may be used for the admixing step. Said kneading elements should ensure sufficient homogenization of the components guaranteeing micro mixing.

The inventive method may include mixing and homogenization of the components A, B and C by the usual methods of plastic technology, wherein the sequence of adding the components may be varied.

As used herein, the term “polystyrene” refers to a polymer that contains monomer residues from one or more monomers selected from styrene, p-methyl styrene, tertiary butyl styrene, dimethyl styrene, nuclear brominated or chlorinated derivatives thereof and combinations thereof.

As used herein, the term “monomer residues” or “polymer made of” or “polymer comprising” specific monomers refers to the monomeric repeat unit in a polymer derived from polymerization of the specific monomers which contain a polymerizable unsaturated group. As used herein, the term “polymer” is meant to encompass homopolymers, copolymers and graft copolymers.

The components A, B and C, as well as the suitable amounts thereof, are further defined in the following.

Impact-modified polystyrene as component A-1 The method according to the present invention employs at least one impact-modified polystyrene as component A-1. The at least one impact-modified polystyrene A-1 typically comprises (or consists of):
A-1.1: at least one polystyrene as component A-1.1,
A-1.2: at least one impact modifying polymer as component A-1.2, and
A-1.3: optionally at least one additive as component A-1.3.

According to a preferred embodiment, the polystyrene A-1.1 comprises at least 30 wt.-%, more preferably at least 60 wt.-%, in particular preferably at least 85 wt.-%, based on the polystyrene A-1.1, of one or more monomers selected from styrene, p-methyl styrene, tertiary butyl styrene, dimethyl styrene, nuclear brominated or chlorinated derivatives thereof and combinations thereof. Preferably, the polystyrene A-1.1 comprises at least 30 wt.-%, more preferably at least 60 wt.-%, in particular preferably at least 85 wt.-%, based on the polystyrene A-1.1, of styrene.

In a preferred embodiment the polystyrene A-1 is selected from high-impact polystyrenes (HIPS).

The preparation, structure, and properties of said polystyrenes are generally described in detail in the literature, e.g. Echte, Haaf, Hambrecht in Angew. Chem. (Int. Ed. Engl.) 20, 344-361, (1981); and in Kunststoffhandbuch, edited by Vieweg and Daumiller, Vol. 4 “Polystyrol”, Carl-Hanser-Verlag Munich (1996).

As used herein, the term “high impact polystyrene” or “HIPS” refers to rubber modified polystyrene, comprising a polystyrene A-1 as matrix material and at least one impact modifying polymer A-1.2 described in the following as elastomeric material. For example, HIPS can be prepared by adding a polybutadiene rubber, or other elastomeric materials, into styrene monomer during polymerization, so it can become chemically bonded to the polystyrene, forming a graft copolymer which helps to incorporate impact modifying polymers A-1.2 into the final resin composition.

As used herein, the term “elastomeric materials” refers to a material that deforms when stress is applied and returns to its original configuration when the stress is removed.

Typically, the elastomeric materials that can be used to make high impact polystyrene (HIPS) is one or more impact modifying polymer A-1.2 comprising monomer residues from styrene, 1,3-butadiene, isoprene, acrylonitrile, ethylene, C₃ to C₁₂ alpha olefins, and combinations thereof.

In some embodiments of the invention, the impact modifying polymer A-1.2 can be a rubbery polymer containing an ethylenic unsaturation. In some cases, the impact modifying polymer A-1.2 can be a co- or homopolymer of one or more C₄₋₆ conjugated diolefins, such as polybutadiene.

In some particular embodiments, the polystyrene composition A-1 is selected from high-impact polystyrenes comprising a polystyrene A-1.1 and at least one impact modifying polymer A-1.2 selected from butadiene rubbers (BR) and styrene-butadiene rubbers (SBR).

The butadiene rubber is a low, medium or high-cis polybutadiene, in particular a medium or high cis-polybutadiene. Typically, the polybutadiene contains not less than 10, preferred not less than 70, most preferred not less than 90 wt.-%, in some cases more than about 93 wt.-%, based on the polybutadiene, of monomer units in the cis-configuration. In many instances, medium cis-polybutadiene has a cis content from about 30 to 50 wt.-%, in some cases from about 35 to 45 wt.-%, based on the polybutadiene.

Suitable butadiene rubbers that can be used in the invention include those commercially available from various sources; for example Buna CB 550 available from Arlanxeo Corporation (Pittsburgh, PA); PB 5800-Schkopau available from the Trinseo LLC (Berwyn, PA); and Diene® 55AC15 and Diene® 70AC15 available from Firestone Polymers LLC (Akron, OH).

Furthermore, the impact modifying polymer A-1.2 may be selected from structurally modified specific butadiene rubbers—for example, with a 1,4-cis and/or 1,4-trans fraction or 1,2- and 1,4-linkage fraction modified relative to conventional rubbers.

Furthermore, instead of butadiene rubber, it is also possible to use other diene rubbers, and also elastomers of the type of ethylene-propylene-diene copolymer (EPDM rubber), and also hydrogenated diene rubbers, as impact modifying polymer A-1.2.

Preferably, the impact-modified polystyrenes A-1 include high-impact polystyrenes which comprise 80 to 99 wt.-%, preferably 85 to 98 wt.-% of polystyrene A-1.1 as styrene matrix, and 1 to 20 wt.-%, preferably 2 to 15 wt.-%, of at least one impact modifying polymer A-1.2, preferably a polybutadiene and/or a styrene-butadiene copolymer with at least one glass transition temperature Tg of less than 0° C., preferably less than −40° C. and most preferably less than −60° C. The glass transition temperature Tg is determined according to ISO 11357-1/-3 with a heating rate of 10 K/min.

The impact modifying polymer A-1.2 is typically present in the form of particles, often having an average particle size (measured by common methods) of at least about 0.25 μm, in some cases at least about 0.5 μm and in other cases at least about 1 μm. Preferably, the average particle size of the particles of the impact modifying polymer A-1.2 can be up to about 12 μm, in some cases up to about 11 μm and in other cases up to about 10 μm. Often, the average particle size of the particles of the impact modifying polymer A-1.2 can be in the range of from 1 μm to 10 μm, e.g. 2, 4 or 7 μm. The average particle size of the particles of the impact modifying polymer A-1.2 can be any value or range between any of the values recited above. The (volume based) average particle size of the impact modifying polymer A-1.2 is typically measured by analyzing the spectra obtained from light scattering through a solution of the particles in a polystyrene solvent, such as methyl ethyl ketone or ethyl acetate. Instruments suitable for this measurement include Horiba's Model LA-920 or Beckman Coulter's LS 13 320.

Typically, the weight average molecular weight (M_{w}) of the polystyrene A-1.1 ranges from 30,000 to 500,000 g/mol, preferably from 50,000 to 250,000 g/mol, more preferably from 70,000 to 240,000 g/mol. In particular the weight average molecular weight (M_{w}) of the polystyrene A-1.1 ranges from 80,000 to 400,000 g/mol, preferably from 120,000 to 300,000 g/mol, more preferably from 150,000 to 250.00 g/mol. In particular the weight average molecular weight (M_{w}) of the polystyrene A-1.1 ranges from 100,000 to 500,000 g/mol, preferably from 130,000 to 360,000 g/mol, more preferably from 150,00 to 350,000 g/mol. Typically molecular weight values are determined using gel permeation chromatography (GPC) using tetrahydrofuran (THF) as eluent and appropriate polystyrene standards. Unless otherwise indicated, the molecular weight values indicated herein are weight average molecular weights (Mw).

Typically, the impact-modified polystyrenes A-1 have a viscosity number VN (measured according to DIN 53726) in the range of 50 to 120 ml/g, preferably 60 to 100 ml/g.

In particular, high-impact polystyrene (HIPS), which has been equipped with one or more additives A-1.3, such as, for example, mineral oil (e.g. medical white oil), lubricants (e.g. metal stearates) stabilizer, antistatic agents, flame retardants or waxes, can be used as impact-modified polystyrene A-1. Suitable additives are known in the art and may be selected from the additives described as component C herein below.

In one embodiment of the invention, the at least one impact-modified polystyrene A-1 comprises (or consists of):
A-1.1: 80 to 99 wt.-%, preferably 85 to 98 wt.-%, based on the total impact modified polystyrene A-1, of at least one polystyrene A-1.1,
A-1.2: 1 to 20 wt.-%, preferably 2 to 15 wt.-%, based on the total impact modified polystyrene A-1, optionally at least one impact modifying polymer A-1.2, and
A-1.3: 0 to 7 wt.-%, preferably 0 to 5 wt.-%, based on the total impact modified polystyrene A-1, of at least one additive A-1.3.

Non-impact-modified polystyrene A-2 The method according to the present invention employs at least one non-impact-modified polystyrene as component A-2. The at least one non-impact-modified polystyrene A-2 typically comprises (or consists of):
A-2.1: at least one polystyrene as component A-2.1, and
A-2.2: optionally at least one additive as component A-2.2.

The at least one polystyrene component A-2.1 may be selected from the polystyrene components A-1.1 described above, but does not comprise impact-modifying polymers. Suitable standard polystyrenes or also called general purpose polystyrenes (GPPS) are prepared by the method of anionic or radical polymerization of styrene or styrene derivatives mentioned above. Preferably, GPPS is prepared by polymerization of styrene or a mixture of styrene with any other copolymerizable monomer. Preferably, GPPS is prepared by polymerization of styrene or a mixture of styrene and one or more monomers selected from p-methyl styrene, tertiary butyl styrene, dimethyl styrene, nuclear brominated or chlorinated derivatives thereof and combinations thereof. Generally, the non-uniformity of the polymer, which may be influenced by the polymerization method, is of minor importance here.

Typically, the weight average molecular weight (M_{w}) of the polystyrene A-2.1 ranges from 50,000 to 500,000 g/mol, preferably from 100,000 to 450,000 g/mol, more preferably from 150,000 to 400,000 g/mol. In particular the weight average molecular weight (M_{w}) of the polystyrene A1 ranges from 200 000 to 375 000 g/mol, preferably from 250,000 to 350,000 g/mol, more preferably about 300,000 g/mol to 350,000 g/mol.

Typically molecular weight values are determined using gel permeation chromatography (GPC) using tetrahydrofuran (THF) as eluent and appropriate polystyrene standards. Unless otherwise indicated, the molecular weight values indicated herein are weight average molecular weights (Mw).

Typically, the non-impact modified polystyrene A-2 have a viscosity number VN (measured according to DIN 53726) in the range of 50 to 130 ml/g, preferably 60 to 120 ml/g.

In particular, general purpose polystyrenes (GPPS), which have been equipped with one or more additives A-2.2, such as, for example, mineral oil (e.g. medical white oil), lubricants (e.g. metal stearates) stabilizer, antistatic agents, flame retardants or waxes, can be used as non-impact modified polystyrene A-2. Suitable additives are known in the art and may be selected from the additives described as component C herein below.

In one embodiment of the invention, the at least one non-impact-modified polystyrene A-2 comprises (or consists of):
A-2.1: 93 to 100 wt.-%, preferably 95 to 100 wt.-%, based on the total non-impact-modified polystyrene A-2, of at least one polystyrene as component A-2.1, and
A-2.2: 0 to 7 wt.-%, preferably 0 to 5 wt.-%, based on the total non-impact-modified polystyrene A-2, of at least one additive A-2.2.

### Stabilizer Component B

According to the invention, the at least one stabilizer component B comprises at least one component selected from:
B-1: at least one sterically hindered phenolic antioxidant as component B-1;
B-2: optionally at least one phosphor-containing co-stabilizer as component B-2; and
B-3: optionally at least one sulfur-containing co-stabilizer as component B-3.

### Sterically Hindered Phenolic Antioxidant (Component B-1)

The sterically hindered phenolic antioxidant component B-1 is preferably selected from antioxidants of the general formula (I-1) and mixtures thereof:

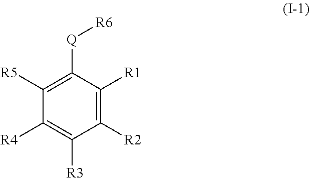

wherein R1 to R5 independently represent hydrogen atoms or alkyl groups having 1 to 70 carbon atoms, wherein the hydrocarbon group optionally comprises at least one hetero atom selected from O and S, and wherein at least one of the substituents R1 and R5 represents a hydrocarbon group having at least 3 carbon atoms, and
R6 independently represents a hydrogen atom or an alkyl group having 1 to 5 carbon atoms, wherein the hydrocarbon group forms a 5- to 6-membered ring structure with at least one of the carbon atoms of hydrocarbon groups of the adjacent substituents R1 and/or R5. Preferably, R6 represents a hydrogen atom.

In a preferred embodiment, the sterically hindered phenolic antioxidant component B-1 is selected from phenolic antioxidants of the general formula (1-2) and mixtures thereof:

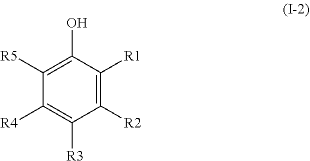

wherein R1 to R5 independently represent hydrogen atoms or alkyl groups having 1 to 70 carbon atoms, wherein the hydrocarbon group optionally comprises at least one hetero atom selected from O and S, and wherein at least one of the substituents R1 and R5 represents a hydrocarbon group having at least 3 carbon atoms.

In a further preferred embodiment, at least one of the substituents R1 and R5 represents a hydrocarbon group having 3 to 6 carbon atoms, preferably an iso-propyl group, a sec-butyl group, a tert.-butyl group, a neo-pentyl group and/or a cyclohexyl group

In one embodiment, at least one of the substituents R2, R3 and R4 represent a hydrogen atom.

In one embodiment, at least one of the substituents R2, R3 and R4 represent a hydrocarbon group having at least 1 carbon atom.

In one embodiment, at least one of the substituents R1 and R5 represents a tert-butyl group; at least two of the substituents R2, R3 and R4 represent a hydrogen atom; and one of the substituents R2, R3 and R4 represent a hydrocarbon group having at least 1 carbon atom.

In one embodiment, the at least one sterically hindered phenolic antioxidant B comprises at least one component B-1.1, selected from compounds of the general formula (1-3):

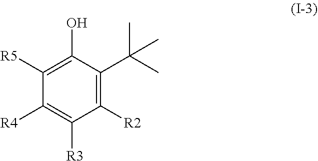

wherein R3 represents a hydrocarbon group having 1 to 70 carbon atoms, wherein the hydrocarbon group optionally, comprises at least one hetero atom, selected from O and S; and R2, R4, and R5 independently represent hydrogen atoms or alkyl groups having 1 to 4 carbon atoms and wherein at least one of the substituents R2, R3, and R4 is not hydrogen.

In one embodiment of the invention, the at least one sterically hindered phenolic antioxidant B is selected from octadecyl 3-(3,5-di-tert-butyl-4-hydroxyphenyl)propionate (CAS-No.: 2082-79-3, Irganox® 1076), 2,6-di-tert-butyl-p-cresol (CAS-No. 87-97-8, Kerobit® TBK), 2-(1,1-dimethylethyl)-6-[(3-(1,1-dimethylethyl)-2-hydroxy-5-methylphenyl]methyl-4-methylphenyl acrylate (CAS-No. 61167-58-6, Irganox® 3052), and mixtures thereof.

Further examples of compounds that may be used as component B include oxygen radical scavengers such as pentaerythritol tetrakis(3-(3,5-di-tert-butyl-4-hydroxyphenyl)propionate) (CAS-No. 6683-19-8, Irganox® 1010, BASF SE), tetrakis[methylene-3-(3,5-di-tert-butyl-4-hydroxyphenyl)-propionate]methane (CAS-No. 6683-19-8, Songnox® 1010, Songwon), 2,6-di-tert-butyl-4-(4,6-bis(octylthio)-1,3,5-triazin-2-ylamino)phe (CAS-No. 991-84-4, Irganox® 565, BASF SE) and blends thereof, carbon radical scavengers such as 2-[1-(2-hydroxy-3,5-di-tert-pentylphenyl)ethyl]-4,6-di-tert-pentylphenyl acrylate (CAS-No. 123968-25-2, Sumilizer® GS, Sumitomo), 2-(1,1-dimethylethyl)-6-[[3-(1,1-dimethylethyl)-2-hydroxy-5-methylphenyl]-methyl]-4-methylphenylacrylat (CAS-No. 61167-58-6, Sumilizer® GM, Sumitomo) and blends thereof.

In one embodiment of the invention, the component B comprises or consists of octadecyl 3-(3,5-di-tert-butyl-4-hydroxyphenyl)propionate (CAS-No.: 2082-79-3, Irganox® 1076) as component B-1.1, a hindered phenolic antioxidant of following formula (I-a):

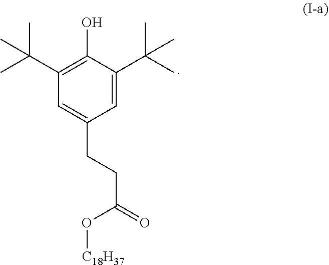

In one embodiment of the invention, the component B comprises or consist of 2-methyl-4,6-bis(octylsulfanylmethyl)phenol (CAS-No. 110553-27-0, Irgafos® 1520) as component B-1.2, a hindered phenolic antioxidant of following formula (I-b):

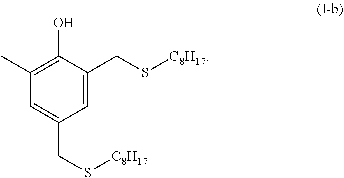

In one embodiment of the invention, the component B comprises a mixture of the hindered phenolic antioxidant of formula (I-a) as component B-1.1 and the hindered phenolic antioxidant of formula (I-b) as component B-1.2, preferably in a weight ratio B-1.1 to B1.2 of 1:2 to 2:1, more preferably 1:1.5 to 1.5:1.

The at least one hindered phenolic antioxidant B-1 may be present in amounts of from 0.01 to less than 0.4 wt.-%, preferably 0.02 to 0.3 wt.-%, often 0.03 to 0.2 wt.-%, for example 0.04 to 0.15 wt.-%, based on the total weight of the polystyrene composition P, provided that the total amount of stabilizer component B does not exceed 0.4 wt.-%, based on the total weight of the polystyrene composition P.

### Phosphor-Containing Co-Stabilizer (Component B-2)

Particular suitable phosphorous-containing co-stabilizers include phosphite components of the general formula (II):

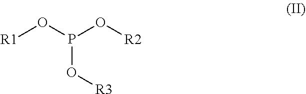

wherein R1 to R3 independently represent aryl groups which are optionally substituted with hydrocarbon groups having 1 to 20 carbon atoms, preferably 3 to 10 carbon atoms. In a preferred embodiment, R1, R2 and R3 each represent a phenyl group having 1 to 3 alkyl groups with 3 to 10 carbon atoms as substituents. Particular preferred phosphorous-containing co-stabilizers include tris(4-nonylphenyl) phosphite (TNPP, CAS-No. 3050-88-2), tris(2,4-di-tert-butylphenol) phosphite (CAS-No. 31570-04-4, Irgafos®168 from BASF SE, Germany) and mixtures thereof.

The phosphorus-co-stabilizers or sulfur-containing co-stabilizers can be used alone or in combination with each other.

The at least one phosphorous-containing co-stabilizer B-2 may be present in amounts of from 0.01 to less than 0.4 wt.-%, preferably 0.02 to 0.3 wt.-%, often 0.03 to 0.2 wt.-%, for example 0.04 to 0.15 wt.-%, based on the total weight of the polystyrene composition P, provided that the total amount of stabilizer component B does not exceed 0.4 wt.-%, based on the total weight of the polystyrene composition P.

### Sulfur-Containing Co-Stabilizer (Component B-3)

Suitable sulfur-containing co-stabilizers include carboxylic acid esters of the general formula (III):

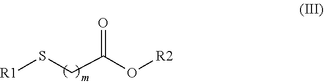

wherein
R1 is independently selected from hydrocarbon groups having 1 to 30 carbon atoms, preferably linear hydrocarbon groups having 5 to 20 carbon atoms, optionally comprising oxygen atoms, in particular in form of carboxyl functional groups,
R2 is independently selected from hydrocarbon groups having 1 to 30 carbon atoms, preferably linear hydrocarbon groups having 10 to 20 carbon atoms, and
m independently represents an integer from 1 to 8, preferably 2 to 4, in particular 2.

In one embodiment, suitable sulfur-containing co-stabilizers include dicarboxylic acid esters of the general formula (III-a):

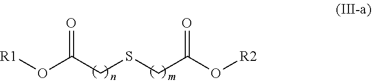

wherein
R1 and R2 are independently selected from hydrocarbon groups having 1 to 30 carbon atoms, preferably linear hydrocarbon groups having 10 to 20 carbon atoms, and n and m independently represent integers from 1 to 8, preferably 2 to 4, in particular 2. Particular preferred sulfur-containing co-stabilizers of formula (III-a) include didodecyl thiodipropionate (Irganox PS 800, BASF SE), ditetradecyl thiodipropionate (CAS-No. 123-28-4; Irganox PS 801, BASF SE), dioctadecyl thiodipropionate (CAS-No. 693-36-7; Irganox PS 802, BASF SE) and mixtures thereof.

In an alternative embodiment, the suitable sulfur-containing co-stabilizers include carboxylic acid esters of the general formula (III-b):

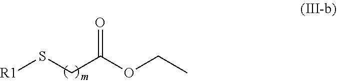

wherein
R1 is selected from hydrocarbon groups having 1 to 30 carbon atoms, preferably linear hydrocarbon groups having 5 to 15 carbon atoms, and m represents an integer from 1 to 8, preferably 2 to 4, in particular 2. Particular preferred sulfur-containing co-stabilizers of formula (III-b) include 2,2-bis[[3-(dodecylthio)-1-oxopropoxy]methyl]propane-1,3-diyl bis[3-(dodecylthio)prop]onate](CAS-No. 29598-76-3, Rianox® 412S, Rianlon, China).

The at least one sulfur-containing co-stabilizer B-3 may be present in amounts of from 0.01 to less than 0.4 wt.-%, preferably 0.02 to 0.3 wt.-%, often 0.03 to 0.2 wt.-%, for example 0.04 to 0.15 wt.-%, based on the total weight of the polystyrene composition P, provided that the total amount of stabilizer component B does not exceed 0.4 wt.-%, based on the total weight of the polystyrene composition P.

### Additives (Component C)

According to the method of the present invention, the polystyrene composition P may comprise up to 10 wt.-%, preferably up to 5 wt.-%, based on the total polystyrene composition P, of one or more additional additive C, which is different from component B. Preferably, the polystyrene composition P may comprise from 0.01 to 10 wt.-%, preferably 0.1 to 5, more preferably 0.1 to 2.5 wt.-%, based on the total polystyrene composition P, of one or more additives C.

The additives C may be admixed with the at least one polystyrene component A and/or with the at least one stabilizer component B during the preparation of the polystyrene composition P.

The additional additive C is typically selected from commonly known additives for polystyrenes and copolymers and compositions thereof. Substances that can be used as additives or auxiliaries are the polymer additives known to the person skilled in the art and described in the prior art (e.g. Plastics Additives Handbook, ed. Schiller et al., 6^{th} Ed, 2009, Hanser). The additive and/or auxiliary can be added either before or during the compounding procedure (mixing of the polymeric components A and B in the melt).

The polystyrene compositions P may comprise, as component C, up to 10 wt.-%, often from 0.01 to 5 wt.-% of usual additives, such as processing aids, stabilizers, oxidation inhibitors, ultra-violet light absorbers, lubricants, flame retardants, colorants, pigments, and plasticizers.

Examples of oxidation inhibitors and heat stabilizers are sterically hindered phenols different from component B-1, various substituted representatives of these groups and mixtures thereof in concentrations of up to 1 wt.-%, based on the total polystyrene composition P.

UV stabilizers, which may be mentioned, and are generally used in amounts of up to 2 wt.-%, based on the total polystyrene composition P, are various substituted resorcinols, salicylates, benzotriazoles and benzophenones different from component B. The afore-mentioned stabilizers are preferably used in amounts of 0.01 to 0.5 wt.-%, more preferably 0.1 to 0.3 wt.-%, based on the total polystyrene composition P.

An example of a processing aid, which can be used in amounts from 0.1 to 5 wt.-%, preferably from 0.5 to 4 wt.-%, based on the total polystyrene composition P, is a homogeneously miscible oil or oil mixture, in particular selected from mineral oils (medical grade mineral oil), vegetable oils (also referred to as plant oils) and silicon oils. In particular, medical grade mineral oil (e.g. DAB 70) may be used as additive C in amounts of 1 to 4 wt.-%, based on the polystyrene composition P.

Preferred lubricants may be selected from long-chain fatty acids, such as stearic acid or behenic acid, salts of fatty acids (e.g. calcium stearate or zinc stearate), esters of fatty acids (e.g. stearyl stearate or pentaerythrityl tetrastearate), amide derivatives of fatty acids (e.g. ethylenebisstearylamide, erucamide, Acrawax®), phosphates (such as tricalcium phosphate), hydrocarbon waxes, such as microcrystalline waxes and paraffin waxes (e.g. Besquare®), and fumed silica (e.g. Aerosil®). Typically, fatty acids are carboxylic acids having a linear or branched, saturated or unsaturated C₅-C₂₅ alkyl chain.

The mentioned additives C may be used alone or in combination of two or more additives C with each other.

### Use and Applications

The method according to the invention can be used to improve the degradation stability of a polystyrene composition P in recycling processes. The inventive method allows the mechanical processing, e.g. during recycling processes, of the obtained polystyrene composition P for several times, including repeated extrusion step at elevated temperatures, e.g. temperature in the range of 180 to 400° C., preferably 200 to 300° C., often in the range of 210 to 270° C., whereas the decomposition of the polystyrene component A and the formation of styrenic monomers is significantly reduced. Repeated extrusion steps at elevated temperatures are typical conditions that a polymer material goes through during the recycling process.

In another aspect of the invention, the invention is concerned with the use of at least one stabilizer component B selected from:
B-1: at least one sterically hindered phenolic antioxidant as component B-1;
B-2: optionally at least one phosphorous-containing co-stabilizer as component B-2; and
B-3: optionally at least one sulfur-containing co-stabilizer as component B-3;
for improving the degradation stability of a polystyrene composition P in recycling processes, wherein the polystyrene composition P comprises at least one polystyrene component A comprising (or consisting of):
A-1: at least one impact-modified polystyrene as component A-1; and/or
A-2: at least one non-impact modified polystyrene as component A-2; and
provided that the polystyrene composition P comprises 0.01 to less than 0.4 wt.-%, preferably 0.02 to 0.3 wt.-%, often 0.03 to 0.2 wt.-%, for example 0.04 to 0.15 wt.-%, based on the total weight of the polystyrene composition P, of the at least one stabilizer component B.

Preferably, the polystyrene composition P comprises (or consists of):
(i) at least one impact-modified polystyrene A-1, and at least one sterically hindered phenolic antioxidants B-1; or
(ii) at least one impact-modified polystyrene A-1, and at least two sterically hindered phenolic antioxidants B-1; or
(iii) at least one impact-modified polystyrene A-1, at least one sterically hindered phenolic antioxidant B-1 and at least one phosphorous-containing co-stabilizer B-2; or
(iv) at least one impact-modified polystyrene A-1, at least one sterically hindered phenolic antioxidant B-1 and at least one sulfur-containing co-stabilizer B-3; or
(v) at least one non-impact-modified polystyrene A-2, and at least one sterically hindered phenolic antioxidant B-1.

As described herein above and further demonstrated by the examples below, admixing 0.01 to less than 0.4 wt.-%, based on the total weight of the polystyrene composition P, of the stabilizer component B and optionally at least one additive C with a polystyrene component A allows to provide a polystyrene composition P with improved degradation stability in recycling processes, i.e. with reduced degradation of the polystyrene component A and reduced formation of styrenic monomer due to polymer degradation during the mechanical processing, e.g. during recycling processes, of the obtained polystyrene composition P for several times, including repeated extrusion step at elevated temperatures, e.g. temperature in the range of 160 to 400° C., preferably 180 to 300° C., often in the range of 200 to 280° C.

### Polystyrene Composition P for Multiple Recycling Cycles

In a further aspect, the present invention relates to a polystyrene composition P for multiple recycling cycles, wherein the polystyrene composition P comprises (or consists of):
A: at least one polystyrene component A comprising:
   A-1: at least one impact-modified polystyrene as component A-1; and/or
   A-2: at least one non-impact modified polystyrene as component A-2; and
B: 0.01 to less than 0.4 wt.-%, preferably 0.02 to 0.3 wt.-%, often 0.03 to 0.2 wt.-%, for example 0.04 to 0.15 wt.-%, based on the total weight of the polystyrene composition P, of at least one stabilizer component B selected from:
   B-1: at least one sterically hindered phenolic antioxidant as component B-1;
   B-2: optionally at least one phosphor-containing co-stabilizer as component B-2; and
   B-3: optionally at least one sulfur-containing co-stabilizer as component B-3; and
C: optionally at least one additive as component C,
wherein A, B, and C sum up to 100 wt.-% of the polystyrene composition P.

Preferably, the polystyrene composition P comprises (or consists of):
(i) at least one impact-modified polystyrene A-1, and at least one sterically hindered phenolic antioxidants B-1; or
(ii) at least one impact-modified polystyrene A-1, and at least two sterically hindered phenolic antioxidants B-1; or
(iii) at least one impact-modified polystyrene A-1, at least one sterically hindered phenolic antioxidant B-1 and at least one phosphorous-containing co-stabilizer B-2; or
(iv) at least one impact-modified polystyrene A-1, at least one sterically hindered phenolic antioxidant B-1 and at least one sulfur-containing co-stabilizer B-3; or
(v) at least one non-impact-modified polystyrene A-2, and at least one sterically hindered phenolic antioxidant B-1.

Preferably, the polystyrene composition P comprises (or consists of):
A: >89.6 to 99.99 wt.-%, preferably 91.7 to 99.97 wt.-%, often 94.8 to 99.87 wt.-%, for example 95.85 to 99.76 wt.-%, based on the total polystyrene composition P, of at least one polystyrene component A;
B: 0.01 to <0.4 wt.-%, preferably 0.02 to 0.3 wt.-%, often 0.03 to 0.2 wt.-%, for example 0.04 to 0.15 wt.-%, based on the total polystyrene composition P, of at least one stabilizer component B; and
C: 0 to 10 wt.-%, preferably 0.01 to 8 wt.-%, often 0.1 to 5 wt.-%, for example 0.2 to 4 wt.-%, based on the total polystyrene composition P, of at least one additive C;
wherein A, B, and C sum up to 100 wt.-% of the polystyrene composition P.

Components A, B and C are as defined herein above. The polymer composition P, in particular the specific amounts of A, B, and C, as disclosed herein may be used in the method for improving the degradation stability according to the present invention.

The at least one polystyrene component A comprises (or consists of) at least one impact-modified polystyrene A-1, at least one non-impact modified polystyrene A-2 or mixtures thereof. Polymer blends of at least one impact-modified polystyrene A-1 and at least one non-impact modified polystyrene A-2 may include:
A-1: 1 to 99.9 wt.-%, preferably 50 to 99.5 wt.-%, often 85 to 99 wt.-%, based on the total polystyrene component A, of at least one impact-modified polystyrene A-1; and
A-2: 0.1 to 99 wt.-%, preferably 0.5 to 50 wt.-%, often 1 to 15 wt.-%, based on the total polystyrene component A, of at least one non-impact modified polystyrene A-2.

The polystyrene composition P comprises as the at least one stabilizer component B preferably a mixture of components B-1, B-2 and/or B-3, in particular comprising (or consisting of):
B-1: 0.01 to <0.4 wt.-%, preferably 0.01 to 0.3 wt.-%, often 0.01 to 0.2 wt.-%, for example 0.04 to 0.15 wt.-%, based on the polymer composition P, of at least one sterically hindered phenolic antioxidant B-1;
B-2: 0 to 0.39 wt.-%, such as 0 to <0.39 wt.-%, preferably 0 to 0.29 wt.-%, often 0 to 0.19 wt.-%, for example 0 to 0.14 wt.-%, based on the polymer composition P, of at least one phosphor-containing co-stabilizer B-2; and
B-3: 0 to 0.39 wt.-%, such as 0 to <0.39 wt.-%, preferably 0 to 0.29 wt.-%, often 0 to 0.19 wt.-%, for example 0 to 0.14 wt.-%, based on the polymer composition P, of at least one sulfur-containing co-stabilizer B-3,
provided that the total amount of stabilizer component(s) B sums up to. 0.01 to <0.4 wt.-%, preferably 0.01 to 0.3 wt.-%, often 0.01 to 0.2 wt.-%, based on the polymer composition P.

If the phosphor-containing co-stabilizer B-2 is present in the polymer composition P, it is typically used in amounts of 0.01 to 0.2 wt.-%, often 0.05 to 0.1 wt.-%, based on the polymer composition P.

If the sulfur-containing co-stabilizer B-3 is present in the polymer composition P, it is typically used in amounts of 0.01 to 0.2 wt.-%, often 0.05 to 0.1 wt.-%, based on the polymer composition P.

If the phosphor-containing co-stabilizer B-2 and the sulfur-containing co-stabilizer B-3 are present in combination in the polymer composition P, the total amount of components B-2 and B-3 typically ranges from 0.01 to 0.2 wt.-%, often 0.05 to 0.1 wt.-%, based on the polymer composition P.

If a further additive C is admixed, the total amount of component C typically ranges from 0 to 10 wt.-%, preferably 0 to 8 wt.-%, often 0 to 5 wt.-%, based on the total polystyrene composition P. The polystyrene composition P often may comprise from 0.01 to 8 wt.-%, preferably 0.1 to 5, more preferably 0.1 to 2.5 wt.-%, based on the total polystyrene composition P, of at least one component C.

In one embodiment, the polystyrene composition P comprises (or consists of):
A: >89.6 to 99.99 wt.-%, preferably 91.7 to 99.97 wt.-%, often 94.8 to 99.87 wt.-%, for example 95.85 to 99.76 wt.-%, based on the total polystyrene composition P, of at least one polystyrene component A;
B-1: 0.01 to <0.4 wt.-%, preferably 0.02 to 0.3 wt.-%, often 0.03 to 0.2 wt.-%, for example 0.04 to 0.15 wt.-%, based on the total polystyrene composition P, of at least one stabilizer component B; and
C: 0 to 10 wt.-%, preferably 0.01 to 8 wt.-%, often 0.1 to 5 wt.-%, for example 0.2 to 4 wt.-%, based on the total polystyrene composition P, of at least one additive C;
wherein A, B, and C sum up to 100 wt.-% of the polystyrene composition P.

In one embodiment, the polystyrene composition P comprises (or consists of):
A-1: >89.6 to 99.99 wt.-%, preferably 91.7 to 99.97 wt.-%, often 94.8 to 99.87 wt.-%, based on the total polystyrene composition P, of at least one impact-modified polystyrene A-1;
B-1.1: 0.005 to 0.395 wt.-%, such as 0.005 to <0.395 wt.-%, preferably 0.01 to 0.29 wt.-%, often 0.015 to 0.185 wt.-%, based on the polymer composition P, of a first sterically hindered phenolic antioxidant as component B-1.1;
B-1.2: 0.005 to 0.395 wt.-%, such as 0.005 to <0.395 wt.-%, preferably 0.01 to 0.29 wt.-%, often 0.015 to 0.185 wt.-%, based on the polymer composition P, of a second sterically hindered phenolic antioxidant as component B-1.2; and
C: 0 to 10 wt.-%, preferably 0.01 to 8 wt.-%, often 0.1 to 5 wt.-%, based on the polymer composition P, of at least one additive C;
wherein components B1.1 and B1.2 are different from each other,
provided that the total amount of stabilizer component(s) B sums up to. 0.01 to <0.4 wt.-%, preferably 0.01 to 0.3 wt.-%, often 0.01 to 0.2 wt.-%, based on the polymer composition P, and wherein A-1, B-1.1, B-1.2, and C sum up to 100 wt.-% of the polystyrene composition P.

In one embodiment, the polystyrene composition P comprises (or consists of):
A-2: >89.6 to 99.99 wt.-%, preferably 91.63 to 99.97 wt.-%, often 94.67 to 99.87 wt.-%, at least one non-impact-modified polystyrene A-2;
B-1: 0.01 to <0.4 wt.-%, preferably 0.02 to 0.37 wt.-%, often 0.03 to 0.33 wt.-%, based on the polymer composition P, of at least one sterically hindered phenolic antioxidant B-1; and
C: 0 to 10 wt.-%, preferably 0.01 to 8 wt.-%, often 0.1 to 5 wt.-%, based on the polymer composition P, of at least one additive C;
wherein A-2, B-1, and C sum up to 100 wt.-% of the polystyrene composition P.

Processes to prepare the polymer composition P are per se known in the art and are described herein above. In general, the process imparts admixing the components A, B and C in the given amounts.

The following examples and claims further illustrate the invention.

### Examples

### 1. General Methods

Commercial polystyrene components were compounded with different stabilizers according to Tables 1.1, 2.1, 2.2 and 3.1.

The following extruder conditions were applied:

| | |
|---|---|
| Extruder: | ZSK 30 |
| Temperature: | 220° C. or 260° C. |
| number of revolutions: | 200 [1/min] |
| throughput: | 10 kg/h |
| no degassing | |

Further details are given below.

Styrene monomer levels were determined by capillary gas chromatography, using head space technique, and with a styrene-based calibration curve.

Viscosity numbers VN were determined according to DIN 53726.

Melt volume-flow rate (MVR, 200° C./5 kg) was determined according to ISO 1133.

1. Examples with Impact-Modified Polystyrene at 220° C. Extrusion Temperature

Commercial high impact-modified polystyrene component (PS 486 M, INEOS Styrolution) was compounded with different stabilizers according to the compositions given in Table 1.1. The following materials were used:

### Impact-Modified Polystyrene Component A:

A-1 high-impact polystyrene HIPS (PS 486 M, INEOS Styrolution)

### Sterically Hindered Phenolic Antioxidant B-1:

B-1.1 octadecyl-[3-(3,5-di-tert-butyl-4-hydroxyphenyl)propionate (Irganox® 1076, CAS-No. 2082-79-3)
B-1.2 2-methyl-4,6-bis(octylsulfanylmethyl)phenol (Irgafos® 1520, CAS-No. 110553-27-0)

### Phosphorous-Containing Co-Stabilizer Components B-2:

B-2.2 tris(nonylphenyl)phosphite (TNPP, CAS-No. 26523-78-4)

TABLE 1.1
Examined compositions and determined styrene levels after 5 extrusion runs.

| | | | | | |
|---|---|---|---|---|---|
| Comp. | Comp. | Comp. | Comp. | Comp. | |
| Ex. 1 | Ex. 2 | Ex. 3 | Ex. 4 | Ex. 5 | Ex. 1 |

Compositions P
(constituents in wt.-%)

| | | | | | | |
|---|---|---|---|---|---|---|
| A-1 | 98.9 | 98.3 | 98.9 | 99.3 | 98.9 | 99.9 |
| B-1.1 | 0.7 | 1.1 | 0.7 | 0.7 | 1.1 | 0.1 |
| B-1.2 | — | — | 0.2 | — | — | — |
| B-2.2 | 0.4 | 0.6 | 0.2 | — | — | — |

Characterization

| | | | | | | |
|---|---|---|---|---|---|---|
| Styrene level ppm | 503 | 509 | 397 | 567 | 585 | 373 |
| after 5 extrusion runs | | | | | | |

The compositions according to Comparative Examples 1 to 5 and Example 1 were extruded 5 times at 220° C. extrusion temperature, and the styrene monomer levels were determined afterwards. It was surprisingly found, that the HIPS composition having the lowest total stabilizer concentration exhibits the best stability towards degradation during extrusion processes and shows the lowest styrene monomer build-up due to degradation of the polystyrene having a total styrene level of 373 ppm (cf. Example 1).

2. Examples with Impact-Modified Polystyrene at 260° C. Extrusion Temperature

Commercial high-impact polystyrene (HIPS) (PS 486 M, INEOS Styrolution) was compounded with different stabilizers according to the compositions given in Tables 2.1 and 2.2. The following materials were used:

### Impact-Modified Polystyrene Component A:

A-1 high-impact polystyrene HIPS (PS 486 M, INEOS Styrolution)

### Sterically Hindered Phenolic Antioxidant B-1:

B-1.1 octadecyl-[3-(3,5-di-tert-butyl-4-hydroxyphenyl)propionate](Irganox®1076, CAS-No. 2082-79-3)
B-1.2 2-methyl-4,6-bis(octylsulfanylmethyl)phenol (Irgafos® 1520, CAS-No. 110553-27-0)

### Phosphorous-Containing Co-Stabilizer Components B-2:

B-2.1 tris(2,4-di-tert.-butylphenyl) phosphite (Irgafos 168, CAS-No. 31570-04-4)
B-2.2 tris(nonylphenyl)phosphite (TNPP, CAS-No. 26523-78-4)

### Sulfur-Containing Co-Stabilizer Components B-3:

B-3.1 didodecyl-3,3′-thiodipropionate (Irganox PS 800, CAS-No. 123-28-4)

### Reference Stabilizer Components (Ref):

Ref-1 Rhenogran® IPPD-80 (RheinChemie), comprising according to product specification: 80 wt.-% of N-Isopropyl-N′-phenyl-1,4-phenylenediamine and 20 wt.-% of elastomer binder and dispersing agents (CAS-No. 101-72-4)
Ref-2 Rhenogran® MBI-80 (RheinChemie), comprising according to product specification: 80 wt.-% of 2-mercaptobenzimidazole and 20 wt.-% of elastomer binder and dispersing agents
Ref-3 1,3,5-triglycidyl isocyanurate (Araldit® PT 810 (Huntsman Advanced Materials), CAS-No. 2451-62-9)
Ref-4 4,4′-bis(phenylisopropyl)diphenylamine (Naugard® 445, CAS-No. 10081-67-1)
Ref-5 trans-beta-nitrostyrene (CAS-No. 5153-67-3)
Ref-6 α-tocopherol (CAS-No. 10191-41-0)

TABLE 2.1
Compositions with HIPS.

| | | | | |
|---|---|---|---|---|
| | Comp. | Comp. | Comp. | Comp. |
| Ex. 2 | Ex. 6 | Ex. 7 | Ex. 8 | Ex. 9 |

Compositions P
(constituents in wt.-%)

| | | | | | |
|---|---|---|---|---|---|
| A-1 | 99.9 | 99.4 | 99.4 | 99.4 | 99.4 |
| B-1.1 | 0.1 | 0.4 | 0.4 | 0.4 | 0.4 |
| B-1.2 | — | 0.2 | — | — | — |
| B-2.1 | — | — | 0.2 | — | — |
| B-2.2 | — | — | — | 0.2 | |
| B-3.1 | — | — | — | — | 0.2 |

Characterization

| | | | | | |
|---|---|---|---|---|---|
| Styrene level, ppm after 5 | 395 | 443 | 433 | 429 | 428 |
| extrusion runs | | | | | |

Further compositions were prepared comprising HIPS as component A and commercially available reference stabilizers:

TABLE 2.2
Compositions with HIPS and reference stabilizers.

| | | | | | |
|---|---|---|---|---|---|
| Comp. | Comp. | Comp. | Comp. | Comp. | Comp. |
| Ex. 10 | Ex. 11 | Ex. 12 | Ex. 13 | Ex. 14 | Ex. 15 |

Compositions P
(constituents in wt.-%)

| | | | | | | |
|---|---|---|---|---|---|---|
| A-1 | 99.42 | 99.42 | 99.3 | 99.6 | 99.6 | 99.4 |
| B-1.1 | 0.1 | 0.1 | 0.1 | 0.1 | 0.1 | 0.1 |
| B-1.2 | — | — | — | — | — | — |
| B-2.1 | — | — | — | — | — | — |
| B-2.2 | — | — | — | — | — | 0.1 |
| B-3.1 | — | — | — | — | — | — |
| Ref-1 | 0.48 | — | — | — | — | — |
| Ref-2 | — | 0.48 | — | — | — | — |
| Ref-3 | — | — | 0.6 | — | — | — |
| Ref-4 | — | — | — | 0.3 | — | — |
| Ref-5 | — | — | — | — | 0.3 | — |
| Ref-6 | — | — | — | — | — | 0.4 |

Characterization

| | | | | | | |
|---|---|---|---|---|---|---|
| Styrene level ppm | 634 | 657 | 641 | 605 | 676 | 611 |
| after 5 extrusion runs | | | | | | |

The compositions according to Example 2 and Comparative Examples 6 to 15 were extruded 5 times at 260° C. extrusion temperature. After five extrusion runs, styrene monomer levels of the extruded compositions were determined. The experimental data are summarized in Tables 2.1 and 2.2.

As can be seen from the data given in Table 2.1, the HIPS composition with less than 0.4 wt.-% of stabilizer B-1 shows the lowest formation of residual styrene after five extrusion runs, having a total styrene level of 395 ppm (Example 2). Surprisingly, combinations with other commercial stabilizers in amounts of more than 0.4 wt.-% (Comp. Ex. 6 to 15) result in a deterioration of the degradation stability of HIPS compositions (cf. Tables 2.1 and 2.2).

3. Examples with GPPS and Extrusions at Different Extrusion Temperatures

Commercial general purpose polystyrene (GPPS) (Polystyrene 168 N, INEOS Styrolution) was compounded with different stabilizers according to the compositions given in Table 3.1. The following materials were used:

### Non-Impact Modified Polystyrene Component A-2

A-2 general purpose polystyrene GPPS (Polystyrene 168 N, INEOS Styrolution)

### Sterically Hindered Phenolic Antioxidant B-1:

B-1.1 octadecyl-[3-(3,5-di-tert-butyl-4-hydroxyphenyl)propionate](Irganox®1076, CAS-No. 2082-79-3)

TABLE 3.1
Prepared GPPS compositions.

| Compositions P | | Comp. |
|---|---|---|
| (constituents in wt.-%) | Ex. 3 | Ex. 16 |
| A-2 | 99.7 | 100 |
| B-1.1 | 0.3 | — |

The compositions according to Example 3 and Comparative Example 16 were extruded 5 times at extrusion temperatures of 220° C. and 260° C., respectively. After five extrusion runs, styrene monomer levels, melt volume-flow rate, and viscosity number of the extruded compositions were determined. The experimental data are summarized in Table 3.2.

TABLE 3.2
Styrene levels after each extrusion run at 220° C. and 260° C.

| Characterization | Ex. 3 | | Comp. Ex. 16 | |
|---|---|---|---|---|
| Extrusion temperature [° C.] | 220 | 260 | 220 | 260 |
| Styrene level after 5 extrusion runs [ppm] | 294 | 372 | 464 | 712 |
| MVR (200° C./5 kg) after 5 extrusion runs | 2.7 | 3.1 | 3.3 | 4.1 |
| [g/10 min] | | | | |
| Viscosity number after 5 extrusion runs | 101 | 98.1 | 95.8 | 94.4 |
| [ml/g] | | | | |

The data obtained from Example 3 and Comparative Example 16 demonstrate that GPPS is well stabilized by 0.3 wt.-% of a sterically hindered phenolic antioxidant.

Even at extrusion temperatures of 260° C., the styrene monomer content in the extruded polymer composition is low with 372 ppm after the fifth extrusion run. By contrast, the styrene monomer level of the GPPS without stabilizer increases to 721 ppm.

The determined data for melt volume-flow rate and viscosity number VN further confirm that the increase in styrene monomer concentration in the compositions is directly connected with the degradation of the polystyrene chains.

1-15. (canceled)

16. A method for improving the degradation stability of a polystyrene composition P in recycling processes including repeated extrusion steps at elevated temperatures, wherein the method comprises:
admixing at least one polystyrene component A with 0.01 to less than 0.4 wt.-%, based on the total weight of the polystyrene composition P, of at least one stabilizer component B and optionally at least one additive component C,
wherein the at least one polystyrene component A comprises:
A-1: at least one impact-modified polystyrene A-1; and
A-2: optionally at least one non-impact modified polystyrene A-2, and
wherein the at least one stabilizer component B comprises at least one component selected from the group consisting of:
B-1: at least one sterically hindered phenolic antioxidant B-1;
B-2: optionally at least one phosphor-containing co-stabilizer B-2; and
B-3: optionally at least one sulfur-containing co-stabilizer B-3.

17. The method of claim 16, wherein the method further comprises:
a) providing the at least one impact-modified polystyrene A-1 and optionally the at one least non-impact modified polystyrene A-2 as the at least one polystyrene component A;
b) providing the at least one sterically hindered phenolic antioxidant B-1, optionally at least one further sterically hindered phenolic antioxidant B-1, optionally the at least one phosphor-containing co-stabilizer B-2, and optionally the at least one sulfur-containing co-stabilizer B-3 as the at least one stabilizer component B,
wherein the at least one further sterically hindered phenolic antioxidant B-1 is different from the first at least one sterically hindered phenolic antioxidant B-1;
c) optionally providing the at least one additive component C;
d) admixing the at least one polystyrene component A with 0.01 to less than 0.4 wt.-%, based on the total weight of the polystyrene composition P, of the at least one stabilizer component B, and optionally the at least one additive component C to obtain the polystyrene composition P; and
e) optionally extruding and cooling the obtained polystyrene composition P.

18. The method of claim 16, wherein the polystyrene composition P comprises:
(i) at least one impact-modified polystyrene A-1, and at least one sterically hindered phenolic antioxidant B-1;
(ii) at least one impact-modified polystyrene A-1, and at least two sterically hindered phenolic antioxidants B-1;
(iii) at least one impact-modified polystyrene A-1, at least one sterically hindered phenolic antioxidant B-1, and at least one phosphor-containing co-stabilizer B-2;
(iv) at least one impact-modified polystyrene A-1, at least one sterically hindered phenolic antioxidant B-1, and at least one sulfur-containing co-stabilizer B-3; or
(v) at least one non-impact-modified polystyrene A-2, and at least one sterically hindered phenolic antioxidant B-1.

19. The method of claim 16, wherein the at least one polystyrene component A is admixed with 0.02 to 0.3 wt.-%, based on the total weight of the polystyrene composition P, of at least one stabilizer component B and optionally at least one additive component C.

20. The method of claim 16, wherein the at least one polystyrene component A is admixed with 0.03 to 0.2 wt.-%, based on the total weight of the polystyrene composition P, of at least one stabilizer component B and optionally at least one additive component C.

21. The method of claim 16, wherein the at least one polystyrene component A is admixed with 0.04 to 0.15 wt.-%, based on the total weight of the polystyrene composition P, of at least one stabilizer component B and optionally at least one additive component C.

22. The method of claim 16, wherein the at least one sterically hindered phenolic antioxidant B-1 is selected from compounds of a general formula (I): 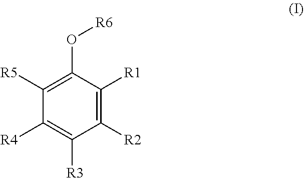
wherein R1 to R5 independently represent hydrogen atoms or alkyl groups having 1 to 70 carbon atoms,
wherein the alkyl groups optionally comprise at least one hetero atom selected from O and S,
wherein at least one of the substituents R1 and R5 represents a hydrocarbon group having at least 3 carbon atoms,
wherein R6 independently represents a hydrogen atom or an alkyl group having 1 to 5 carbon atoms, and
wherein the alkyl group of R6 forms a 5- to 6-membered ring structure with at least one of the carbon atoms of the alkyl groups of the adjacent substituents R1 and/or R5.

23. The method of claim 16, wherein the phosphor-containing co-stabilizer B-2 is a phosphite component of a general formula (II): 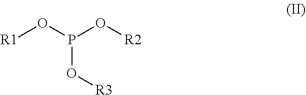
wherein R1 to R3 independently represent aryl groups, which are optionally substituted with hydrocarbon groups having 1 to 20 carbon atoms.

24. The method of claim 16, wherein the sulfur-containing co-stabilizer B-3 is a carboxylic acid ester of the general formula (III): 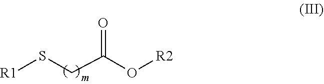
wherein R1 is independently selected from hydrocarbon groups having 1 to 30 carbon atoms and optionally comprising oxygen atoms,
wherein R2 is independently selected from hydrocarbon groups having 1 to 30 carbon atoms, and
wherein m independently represents an integer from 1 to 8.

25. A polystyrene composition P for multiple recycling cycles including repeated extrusion steps at elevated temperatures, wherein the polystyrene composition P comprises:
A: at least one polystyrene component A comprising:
A-1: at least one impact-modified polystyrene A-1; and
A-2: optionally at least one non-impact modified polystyrene A-2;
B: 0.01 to less than 0.4 wt.-%, based on the total weight of the polystyrene composition P, of at least one stabilizer component B selected from the group consisting of:
B-1: at least one sterically hindered phenolic antioxidant B-1;
B-2: optionally at least one phosphor-containing co-stabilizer B-2; and
B-3: optionally at least one sulfur-containing co-stabilizer B-3; and
C: optionally at least one additive component C,
wherein A, B, and C sum up to 100 wt.-% of the polystyrene composition P.

26. The polystyrene composition P of claim 25, wherein the polystyrene composition P comprises:
(i) at least one impact-modified polystyrene A-1, and at least one sterically hindered phenolic antioxidant B-1;
(ii) at least one impact-modified polystyrene A-1, and at least two sterically hindered phenolic antioxidants B-1;
(iii) at least one impact-modified polystyrene A-1, at least one sterically hindered phenolic antioxidant B-1, and at least one phosphor-containing co-stabilizer B-2;
(iv) at least one impact-modified polystyrene A-1, at least one sterically hindered phenolic antioxidant B-1, and at least one sulfur-containing co-stabilizer B-3; or
(v) at least one non-impact-modified polystyrene A-2, and at least one sterically hindered phenolic antioxidant B-1.

27. The polystyrene composition P of claim 25, wherein the polystyrene composition P comprises:
A: >89.6 to 99.99 wt.-%, based on the total weight of the polystyrene composition P, of at least one polystyrene component A;
B: 0.01 to <0.4 wt.-%, based on the total weight of the polystyrene composition P, of at least one stabilizer component B; and
C: 0 to 10 wt.-%, based on the total weight of the polystyrene composition P, of at least one additive C;
wherein A, B, and C sum up to 100 wt.-% of the polystyrene composition P.

28. The polystyrene composition P of claim 25, wherein the at least one stabilizer component B comprises:
B-1: 0.01 to <0.4 wt.-%, based on the total weight of the polymer composition P, of at least one sterically hindered phenolic antioxidant B-1;
B-2: 0 to 0.39 wt.-%, based on the total weight of the polymer composition P, of at least one phosphor-containing co-stabilizer B-2; and
B-3: 0 to 0.39 wt.-%, based on the total weight of the polymer composition P, of at least one sulfur-containing co-stabilizer B-3,
wherein the total amount of the at least one stabilizer component B sums up to 0.01 to <0.4 wt.-% based on the total weight of the polymer composition P.

29. The polystyrene composition P of claim 28, wherein the at least one stabilizer component B comprises:
B-1: 0.01 to 0.3 wt.-%, based on the total weight of the polymer composition P, of the at least one sterically hindered phenolic antioxidant B-1;
B-2: 0 to <0.39 wt.-%, based on the total weight of the polymer composition P, of the at least one phosphor-containing co-stabilizer B-2; and
B-3: 0 to <0.39 wt.-%, based on the total weight of the polymer composition P, of the at least one sulfur-containing co-stabilizer B-3,
wherein the total amount of the at least one stabilizer component B sums up to 0.01 to <0.3 wt.-% based on the total weight of the polymer composition P.

30. The polystyrene composition P of claim 28, wherein the at least one stabilizer component B comprises:
B-1: 0.01 to 0.2 wt.-%, based on the total weight of the polymer composition P, of the at least one sterically hindered phenolic antioxidant B-1;
B-2: 0 to 0.29 wt.-%, based on the total weight of the polymer composition P, of the at least one phosphor-containing co-stabilizer B-2; and
B-3: 0 to 0.29 wt.-%, based on the total weight of the polymer composition P, of the at least one sulfur-containing co-stabilizer B-3,
wherein the total amount of the at least one stabilizer component B sums up to 0.01 to <0.2 wt.-% based on the total weight of the polymer composition P.

31. The method of claim 23, wherein R1 to R3 independently represent aryl groups, which are optionally substituted with hydrocarbon groups having 3 to 10 carbon atoms.

32. The method of claim 24,
wherein R1 is independently selected from linear hydrocarbon groups having 5 to 20 carbon atoms and optionally comprising carboxyl groups,
wherein R2 is independently selected from linear hydrocarbon groups having 10 to 20 carbon atoms, and
wherein m independently represents an integer from 2 to 4.

33. The polystyrene composition P of claim 25, wherein the weight percentage of the at least one stabilizer component B is 0.02 to 0.3 wt.-%, based on the total weight of the polystyrene composition P.

34. The polystyrene composition P of claim 25, wherein the weight percentage of the at least one stabilizer component B is 0.03 to 0.2 wt.-%, based on the total weight of the polystyrene composition P.

35. The polystyrene composition P claim 25, wherein the weight percentage of the at least one stabilizer component B is 0.04 to 0.15 wt.-%, based on the total weight of the polystyrene composition P.
